(19) United States
(12) Patent Application Publication
(10) Pub. No.: US 2010/0054440 A1
(43) Pub. Date: Mar. 4, 2010

(54) COMMUNICATION SUPPORT SYSTEM, CORRESPONDENCE INFORMATION MANAGING APPARATUS, COMMUNICATION SUPPORT METHOD AND PROGRAM

(76) Inventor: Kazushige Ishikawa, Tokyo (JP)

Correspondence Address: Mr. Jackson Chen, 6535 N. STATE HWY 161, IRVING, TX, 75039, US

(21) Appl. No.: 12/440,974

(22) PCT Filed: Sep. 28, 2007
(86) PCT No.: PCT/JP2007/069008

§ 371 Date: Mar. 12, 2009

(30) Foreign Application Priority Data
Oct. 2, 2006 (JP) 2006-270560

(51) Int. Cl. H04M 3/42

(52) U.S. Cl. 379/201.12

(57) ABSTRACT

To a correspondence information storage, correspondence information establishing a correspondence between an information processing apparatus in an available state and a communication terminal is registered. When a user issues a call by use of a communication terminal 11 to a communication terminal 12, call controllers 10-A and 10-B detect call-issuing-side and call-termination-side communication terminals 11 and 12. A correspondence information managing apparatus 20 retrieves correspondence information pieces of the communication terminals 11 and 12 from the correspondence information storage. The call controllers 10-A and 10-B send, when the correspondence information managing apparatus 20 retrieves both of the correspondence information pieces of the communication terminals 11 and 12, an availability notification indicating availability of an information processing apparatus of a call peer to information processing apparatuses 21 and 22 associated with the communication terminals 11 and 12.

### TECHNICAL FIELD

The present invention relates to a communication support technique in which between users conducting a call by use of communication terminals such as a fixed telephone and a cellular, data is also transferred using an information processing apparatus to thereby efficiently promote communication between the users, and in particular, to a communication support technique in which it is possible to know whether or not an information processing apparatus of the call peer is available only by conducting a call issuing operation.

### BACKGROUND ART

There has been known a communication support system in which data is also transferred using an information processing apparatus between users conducting a call by use of communication terminals (reference is to be made to, for example, Patent Document 1).

In the communication support system described in Patent Document 1, a user first issues a call to a call peer by using an own communication terminal. As a result, a call-issuing-side Private Branch eXchange (PBX) accommodating a call-issuing-side communication terminal establishes a correspondence between a terminal number of the call-issuing-side communication terminal and a terminal number of a call-termination-side communication terminal and registers it to a database (DB) in its own exchange, and an exchange in a call-termination-side PBX establishes a correspondence between a terminal number of the call-issuing-side communication terminal and a terminal number of the call-termination-side communication terminal and registers it to a DB in its own exchange. At this point of time, the user is not able to know whether or not the information processing apparatus of the call peer is available.

Thereafter, either one of the user, i.e., the user of the call-issuing-side communication terminal or the call-termination-side communication terminal (for example, the user of the call-issuing-side communication terminal) activates a multimedia application program on his or her own information processing apparatus and inputs the terminal number of the call-issuing-side communication terminal. Resultantly, the communication processing apparatus sends an IP address of the apparatus and the terminal number of the call-issuing-side communication terminal to the exchange in call-issuing-side PBX.

The exchange in the call-issuing-side PBX registers the IP address of the information processing apparatus being used by a call issuing person, by establishing a correspondence to the terminal numbers of the call-issuing-side communication terminal and the call-termination-side communication terminal beforehand registered to the DB; by using this as a trigger, the exchange in call-issuing-side PBX issues to the exchange in the call-termination-side PBX a query for whether or not a correspondence has been established between an information processing apparatus and the call-termination-side communication terminal.

In reply to the query, the exchange in the call-termination-side PBX refers to the DB in its own exchange and returns a response indicating whether or not a correspondence has been established between an information processing apparatus and the call-termination-side communication terminal. At this point of time, since the IP address of the information processing apparatus has not been registered to the DB with a correspondence established to the terminal number of the call-termination-side communication terminal, the exchange returns a response indicating absence of the information processing apparatus to which the correspondence has been established; however, if the IP address of the information processing apparatus has been registered with a correspondence established to the terminal number of the call-termination-side communication terminal, the exchange returns a response indicating presence of the information processing apparatus to which the correspondence has been established.

When the response is returned from the exchange in the call-termination-side PBX, the exchange in call-issuing-side PBX transmits the response to the information processing apparatus being used by the call issuer. As a result, the information processing apparatus displays the contents of the response; by viewing the display, the call issuer recognizes whether or not the information processing apparatus of the call peer is available.

Patent Document 1: Japanese Patent Laid-Open Publication No. 2005-12380

### DISCLOSURE OF THE INVENTION

### Problem to be Solved by the Invention

However, in the associated technique described above, the data communication is also possible using the information processing apparatuses between the users conducting a call by use of the communication terminals and it is possible to efficiently promote communication. However, according to the conventional technique above, whether or not the information processing apparatus of the call peer is available cannot be recognized by the user only by carrying out the call issuing operation; hence, there exists a problem in which to recognize whether or not the information processing apparatus of the call peer is available, it is required that the user conducting the call carries out operation to input the terminal number of the communication terminal to the information processing apparatus and to transmit this terminal number and the IP address of the information processing apparatus to the PBX. This is because according to the conventional technique, the exchange of the PBX accommodating the user issues a query to the PBX accommodating the call peer for whether or not a correspondence has been established between an information processing apparatus and the communication terminal of the call peer, by using as a trigger an event in which the IP address of the information processing apparatus sent from the information processing apparatus of the user is registered to the DB with a correspondence established to the terminal numbers of the beforehand-registered call-issuing-side and call-termination-side communication terminals; the IP address of the information processing apparatus can be registered with a correspondence established to the terminal numbers of the call-issuing-side and call-termination-side communication terminals only in a state in which the call is being conducted.

It is therefore an exemplary object of the present invention to provide a communication support system, a correspondence information managing apparatus, a communication support method, and a program in which only through conducting a call issuing operation by a user, at least a call issuer or a call receiver can recognize whether or not an information processing apparatus of the call peer is available.

### Means for Solving the Problem

To achieve the above exemplary object, the present invention includes exemplary aspects as below.

A communication support system according to an exemplary aspect of the present invention includes:

a correspondence information storage to which correspondence information establishing a correspondence between an information processing apparatus in an available state and a communication terminal is registered;

detecting means for detecting a call-issuing-side communication terminal and a call-termination-side communication terminal;

retrieval means for retrieving, from the correspondence information storage, correspondence information related to the call-issuing-side and call-termination-side communication terminals detected by the detecting means; and

notifying means for transmitting, when the retrieval means retrieves the correspondence information related to the call-issuing-side and call-termination-side communication terminals, an availability notification indicating availability of an information processing apparatus of a call peer to at least one information processing apparatus selected from an information processing apparatus associated with the call-issuing-side communication terminal and an information processing apparatus associated with the call-termination-side communication terminal.

Moreover, a correspondence information managing apparatus according to an exemplary aspect of the present invention includes:

a correspondence information storage to which correspondence information establishing a correspondence between an information processing apparatus in an available state and a communication terminal is registered; and

retrieval means for inputting, from an external device, information of a call-issuing-side communication terminal and a call-termination-side communication terminal between which a call is being conducted; retrieving, from the correspondence information storage, correspondence information related to the call-issuing-side and call-termination-side communication terminals; and returning the correspondence information.

Also, an information processing apparatus according to an exemplary aspect of the present invention includes display control means for displaying a symbol indicating availability of an information processing apparatus of a call peer in a situation wherein under condition that both of correspondence information pieces related to a call-issuing-side communication terminal and a call-termination-side communication terminal between which a call is being conducted are registered to a correspondence information storage to which correspondence information establishing a correspondence between an information processing apparatus in an available state and a communication terminal is registered, when an availability notification is received from an external device which transmits an availability notification to at least one information processing apparatus selected from an information processing apparatus associated with the call-issuing-side communication terminal and an information processing apparatus associated with the call-termination-side communication terminal.

In addition, a call controller according to an exemplary aspect of the present invention includes:

detecting means for detecting a call-issuing-side communication terminal and a call-termination-side communication terminal; and

notifying means for transmitting; when retrieval means, which retrieves correspondence information related to the call-issuing-side and call-termination-side communication terminals detected by the detecting means from a correspondence information storage, retrieves the correspondence information related to the call-issuing-side and call-termination-side communication terminals; an availability notification indicating availability of an information processing apparatus of a call peer to at least one information processing apparatus selected from an information processing apparatus associated with the call-issuing-side communication terminal and an information processing apparatus associated with the call-termination-side communication terminal.

Furthermore, a communication support method according to an exemplary aspect of the present invention includes:

detecting a call-issuing-side communication terminal and a call-termination-side communication terminal;

retrieving, from a correspondence information storage to which correspondence information establishing a correspondence between an information processing apparatus in an available state and a communication terminal is registered, correspondence information related to the call-issuing-side and call-termination-side communication terminals detected by the detecting means; and

transmitting, when the retrieval means retrieves the correspondence information related to the call-issuing-side and call-termination-side communication terminals, an availability notification indicating availability of an information processing apparatus of a call peer to at least one information processing apparatus selected from an information processing apparatus associated with the call-issuing-side communication terminal and an information processing apparatus associated with the call-termination-side communication terminal.

In addition, a program according to an exemplary aspect of the present invention causes a computer including a correspondence information storage to which correspondence information establishing a correspondence between an information processing apparatus in an available state and a communication terminal is registered, to function as retrieval means for inputting, from an external device, information of a call-issuing-side communication terminal and a call-termination-side communication terminal between which a call is being conducted; retrieving, from the correspondence information storage, correspondence information related to the call-issuing-side and call-termination-side communication terminals; and returning the correspondence information.

### Advantages of the Invention

In accordance with the present invention, only through conducting a call issuing operation by a user by use of a communication terminal, at least a call issuer or a call receiver can recognize whether or not an information processing apparatus of the call peer is available. This is because there are provided a correspondence information storage to which correspondence information establishing a correspondence between an information processing apparatus available for the user and a communication terminal is registered; and notification means for transmitting, if correspondence information related to the call-issuing-side communication terminal and the call-termination-side communication terminal detected by detecting means is registered to the correspondence information storage, an availability notification indicating availability of an information processing apparatus of a call peer to at least one of the information processing apparatus associated with the call-issuing-side communication terminal and that associated with the call-termination-side communication terminal. That is, since the correspondence information does not include information related to the communication terminal of the call peer, it can be registered to the correspondence information storage before the communication is started; further, since the processing to determine whether or not the information processing apparatus of the call peer is available is executed using as a trigger an event in which the detecting means detects the call-issuing-side communication terminal and the call-termination-side communication terminal, the user can know, only by conducting the call issuing operation, whether or not the information processing apparatus of the call peer is in an available state.

### Best Mode for Carrying out the Invention

Next, a best mode for carrying out the invention will be described in detail by referring to drawings.

### First Exemplary Embodiment

Referring to FIG. 1, a first exemplary embodiment of the communication support system in accordance with the present invention includes a communication network 1, call controllers 10-A and 10-B linked with the communication network 1, communication terminals 11 and 12 connected respectively to the call controllers 10-A and 10-B, an information processing network 2, information processing apparatuses 21 and 22 such as personal computers coupled with the information processing network 2 and a correspondence information managing apparatus 20 such as personal computers coupled with the information processing network 2. Although the communication network 1 is a line switching network in general, it may be a VoIP network employing a Session Initiation Protocol (SIP) today. Also, the information processing network 2 is in general an intranet in a firm or the Internet.

The communication terminal 11 and the information processing apparatus 21 are used by one and the same user (Mr. Taro) and it is indicated that a correspondence is established between the communication terminal and the information processing apparatus in accordance with the present invention. Similarly, the communication terminal 12 and the information processing apparatus 22 are used by one and the same user (Ms. Hanako) and it is indicated that a correspondence is established between the communication terminal and the information processing apparatus in accordance with the present invention. The correspondence established between the communication terminal and the information processing apparatus also applies to a case in which the communication terminal and the information processing apparatus are commonly used and are temporarily employed by one and the same user.

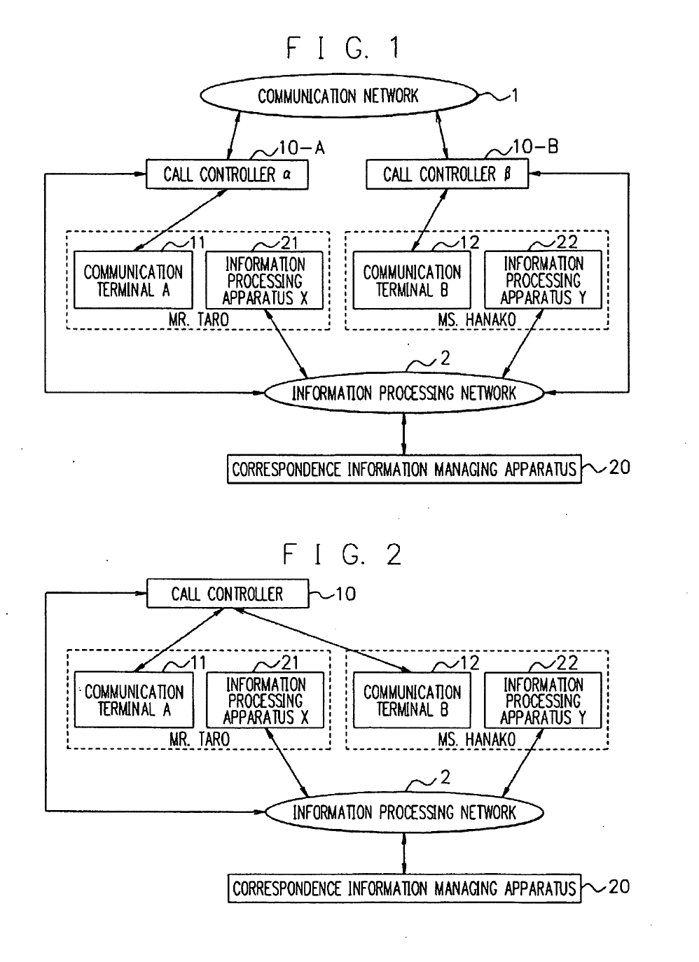

On the other hand, referring to FIG. 2, it includes a call controller 10, communication terminals 11 and 12 linked with the call controller 10, an information processing network 2, and information processing apparatuses 21 and 22 as well as a correspondence information managing apparatus 20 connected to the information processing network 2; when compared with FIG. 1, the communication terminals 11 and 12 of FIG. 2 are linked with one and the same call controller 10 and the communication network 1 is dispensed with in the configuration. The configuration of FIG. 2 is a configuration implemented by simplifying that of FIG. 1.

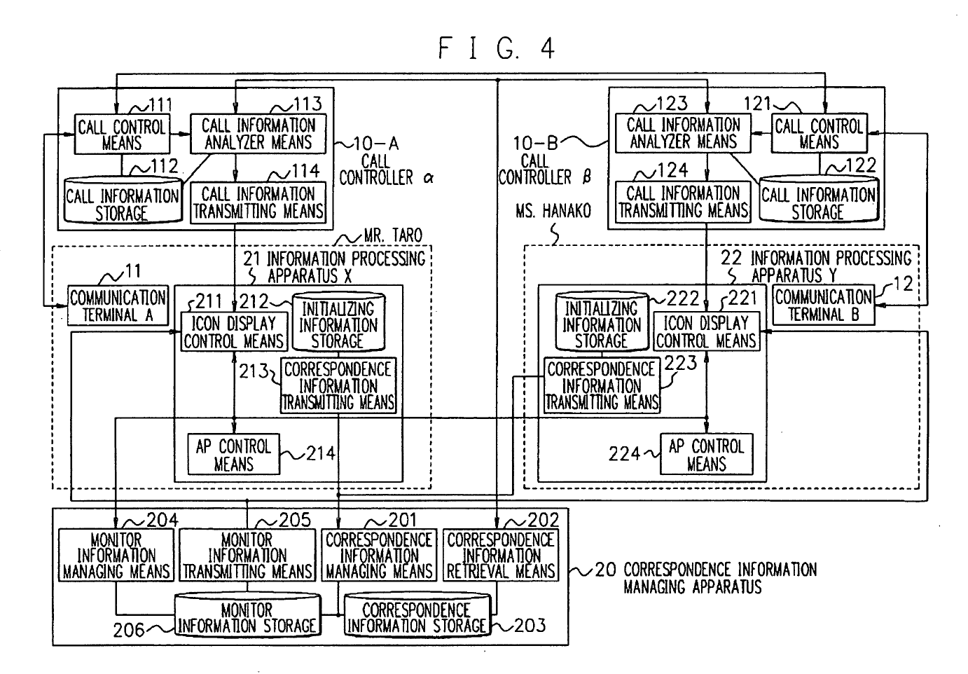

Next, referring to FIG. 4, the configuration Of FIG. 1 will be described in more detail.

### [Configuration of Call Controllers 10-A and 10-B]

The call controller 10-A includes call control means 111, a call information storage 112, call information analyzer means 113, and call information transmitting means 114. Outlines of these means are as follows.

The call control means 111 receives a call issuance from the communication terminal 11 and opens a communication line between itself and the call controller 10-B accommodating the communication terminal 12 which will be a call peer via the communication network 1 as well as stores the information in the call information storage 112. Or, the call control means 111 receives a call terminated from the communication terminal 12 and opens a communication line via the communication network 1 between itself and the communication terminal 11 accommodated in the call control means 111 as well as stores the information in the call information storage 112.

The call information analyzer means 113 analyzes call start or end information from the call control means 111 and acquires an ID of the communication terminal 11 or 12 which has started or ended the call (for example, a communication terminal ID “sip:user01@hostA.domain.com” exemplified in FIG. 7). Also, the call information analyzer means 113 obtains, by using correspondence information retrieval means 202 included in the correspondence information managing apparatus 20, associated information pieces such as an ID of the information processing apparatus 21 or 22 associated with the communication terminal 11 or 12 (for example, an information processing apparatus ID “pc01@domain.com” exemplified in FIG. 7) and a display name (for example, a display name “Taro (firm)” exemplified in FIG. 7).

The call information transmitting means 114 sends, to icon display control means 211, the correspondence information (IDs of communication terminals which are being in a call or which were in a call and an information processing apparatus ID, a display name, and the like associated with those terminals) analyzed and acquired by the call information analyzer means 113.

The call controller 10-B includes call control means 121, a call information storage 122, call information analyzer means 123, and call information transmitting means 124. Outlines of these means are similar respectively to those of the call control means 111, the call information storage 112, the call information analyzer means 113, and the call information transmitting means 114 of the call controller 10-A described above. Here, the information processing apparatus 21 associated with the communication terminal 11 attains correspondence information of the call peer from the call controller 10-A accommodating the communication terminal 11, and the information processing apparatus 22 associated with the communication terminal 12 obtains correspondence information of the call peer from the call controller 10-B accommodating the communication terminal 12.

The call controller 10-A having such function is implementable by a computer; in a case of implementation by a computer, it is implemented, for example, as follow. A disk, a semiconductor memory, or another recording medium having recorded a program which causes the computer to function as the call controller 10-A is prepared, and the computer is made to read the program. The computer controls its own operation according to the program thus read to realize the call control means 111, the call information analyzer means 113, and the call information transmitting means 114 on the computer itself.

[Correspondence Information Managing Apparatus 20]

The correspondence information managing apparatus 20 includes correspondence information managing means 201, correspondence information retrieval means 202, a correspondence information storage 203, monitor information managing means 204, monitor information transmitting means 205, and a monitor information storage 206. Outlines of these means are as follows.

The correspondence information managing means 201 stores, in the correspondence information storage 203, correspondence information sent from correspondence information transmitting means 213 and 223 included in the information processing apparatuses 21 and 22. Or, the correspondence information managing means 201 deletes correspondence information beforehand stored.

The correspondence information retrieval means 202 retrieves, based on the communication terminal IDs sent from the call information analyzer means 113 and 123 included in the call controllers 10-A and 10-B, correspondence information including IDs of the information processing apparatuses associated with the communication terminals of the communication terminal IDs, from the correspondence information storage 203; and returns it.

FIG. 7 shows an example of the contents of the correspondence information storage 203, which keeps a pair of an information processing apparatus ID and a communication terminal ID between which a correspondence is established by the user, and also stores a corresponding display name and a rank as a sorting order in the information retrieval. Here, the information processing apparatus ID is an ID employed to uniquely identify the information processing apparatus, and the communication terminal ID is an ID adopted to uniquely identify the communication terminal.

For example, information processing apparatuses associated with the communication terminal identified by the communication terminal ID “sip:user01@hostA.domain.com” are two information processing apparatuses identified by the information processing apparatus IDs “pc01@domain.com” and “pc01a@domain.com” and their ranks are respectively 1 and 2; hence, the information processing apparatus identified by the information processing apparatus ID “pc01@domain.com” is preferentially used. Additionally, if the information processing apparatus identified by the information processing apparatus ID “pc01@domain.com” has not been activated, this information is absent; therefore, the information processing apparatus identified by the information processing apparatus ID “pc01a@domain.com” is used although the rank thereof is 2. On the other hand, communication terminals associated with the information processing apparatus identified by the information processing apparatus ID “pc01@domain.com” are two communication terminals identified by the communication terminal IDs “sip:user01@hostA.domain.com” and “sip:user03@hostA.domain.com”; in any case wherein either one of the communication terminals starts a call, the information processing apparatus identified by the information processing apparatus ID “pc01@domain.com” is the information processing apparatus as an object to establish the correspondence.

The monitor information managing means 204 stores, in the monitor information storage 206, the monitor information pieces delivered from the icon display control means 211 and 221 included in the information processing apparatuses 21 and 22. Or, the monitor information managing means 204 deletes information stored in advance.

The monitor information transmitting means 205 notifies, when the contents stored in the correspondence information storage 203 are changed through operation of the correspondence information managing means 201, the event of the change in the correspondence information to both of the information processing apparatuses 21 and 22 based on the contents designated by the monitor information storage 206.

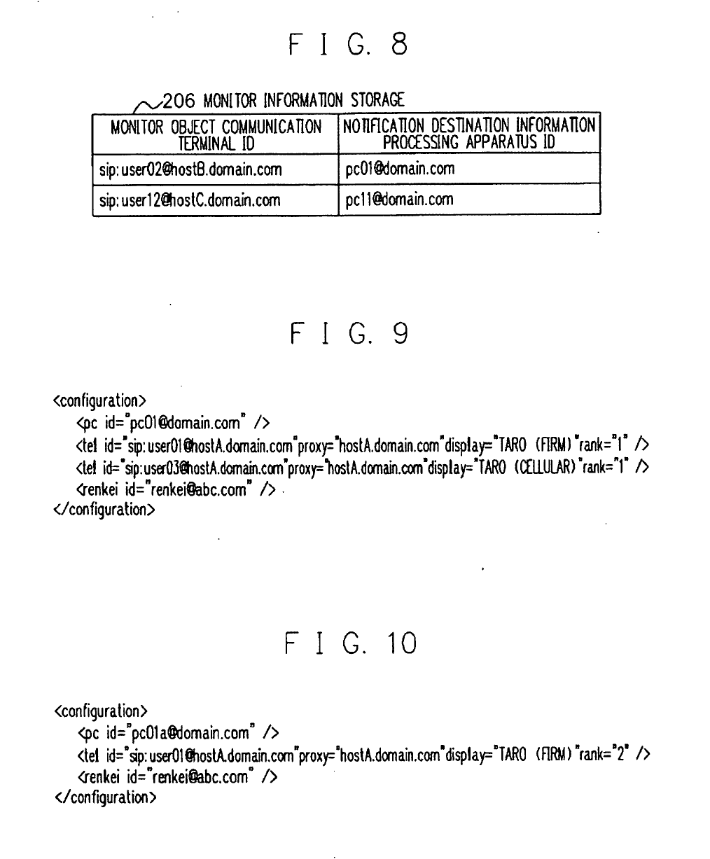

FIG. 8 shows an example of the contents of the monitor information storage 206, which keeps a pair of a monitor object communication terminal ID and a notification destination information processing apparatus ID. Here, the monitor object communication terminal ID is an ID adopted to uniquely identify the communication terminal as a monitor object, and the notification destination information processing apparatus ID is an ID used to uniquely identify the information processing apparatus employed as a notification destination.

For example, when an information processing apparatus to be associated with a communication terminal identified by the monitor object communication terminal ID “sip:user02@hostB.domain.com” is registered anew to the correspondence information storage 203, this event is notified to the information processing apparatus identified by the notification destination information processing apparatus ID “pc01@domain.com”.

The correspondence information managing apparatus 20 having such function is implementable by a computer; in a case of implementation by a computer, it is implemented for example as follow. A disk, a semiconductor memory, or another recording medium having recorded a program which causes the computer to function as the correspondence information managing apparatus 20 is prepared, and the computer is made to read the program. The computer controls its own operation according to the program thus read to realize the correspondence information managing means 201, the correspondence information retrieval means 202, the monitor information managing means 204, and monitor information transmitting means 205 on the computer itself.

### [Information Processing Apparatuses 21 and 22]

The information processing apparatus 21 includes icon display control means 211, an initializing information storage 212, correspondence information transmitting means 213, and application program (AP) control means 214. Outlines of these means are as follows.

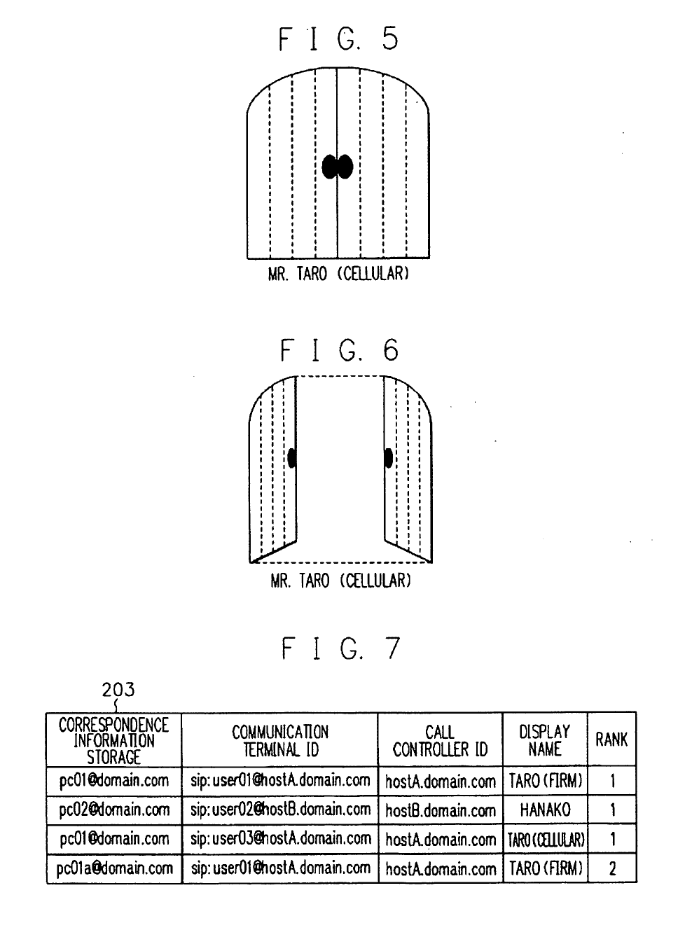

The icon display control means 211 displays, according to the correspondence information (IDs of communication terminals which are being in a call or which were in a call and information processing apparatus IDs, display names, and the like associated with those terminals) sent from the call information transmitting means 114 in the call controller 10-A, symbols (e.g., an icon and a character string indicating a call peer exemplified in FIG. 5) indicating in the case of the call start that the information processing apparatus of the call peer is available, and the symbols are set to a non-display state in the case of the call end. In addition, the icon display control means 211 gives consideration to a situation wherein the information processing apparatus corresponding to the communication terminal of the call peer was absent immediately after the call start, but a login is thereafter conducted to the correspondence information processing apparatus as well as a situation wherein a logout is carried out for the apparatus before the call end, and displays, according to monitor information sent from the monitor information transmitting means 205 of the correspondence information managing apparatus 20, symbols (e.g., an icon and a character string indicating a call peer exemplified in FIG. 5) indicating in the case of the new login that the information processing apparatus of the call peer is available, and sets the symbols to a non-display state in the case of the logout.

The correspondence information transmitting means 213 is activated when the user conducts a login to the information processing apparatus 21 or at appropriate timing equivalent to the login, and obtains its own information processing apparatus ID, a communication terminal ID for establishing a correspondence, a corresponding display name, and the like from the initializing information storage 212 to transmit them to the correspondence information managing means 201 included in the correspondence information managing apparatus 20. Through this processing, the correspondence information regarding the information processing apparatus 21 for which the login is conducted is registered by the correspondence information managing means 201 to the correspondence information storage 203. However, in a situation wherein the information processing apparatus 21 is shared and private information pieces such as the communication terminal ID and the display name cannot be kept as initializing information in the initializing information storage 212, the correspondence information is manually inputted at the login of private information such as the communication terminal ID; or, the correspondence information is kept in a private IC card or the like (including a contactless IC card “FeliCa” mounted in a cellular) and is read from the IC card at the login. Here, the correspondence information sent to the correspondence information managing apparatus 20 is kept as initializing information in a memory (not shown) of the information processing apparatus 21 in consideration of a case wherein the information is manually inputted or is temporarily acquired from the IC card or the like.

Moreover, the correspondence information transmitting means 213 is activated when the user conducts a logout from the information processing apparatus 21 or at appropriate timing equivalent to the logout, and transmits information to the correspondence information managing apparatus 20 at login and sends again the initializing information kept in the memory of the information processing apparatus 21 to the correspondence information managing means 201 included in the correspondence information managing apparatus 20. By this processing, the correspondence information regarding the information processing apparatus 21 for which the logout is conducted is deleted by the correspondence information managing means 201 from the correspondence information storage 203.

The AP control means 214 judges, when the user declares some intention to a symbol indicating possibility of data transfer to the information processing apparatus of the call peer displayed on the screen of the information processing apparatus 21, the contents of the intention; activates an appropriate application program on the information processing apparatuses 21 and 22, opens a data communication line between the application programs above, and starts data communication. Here, the AP control means 214 is capable of recognizing the ID of the information processing apparatus 22 to be used as the call peer, based on the notification delivered from the icon display control means 211.

In addition, the AP control means 214 terminates the data communication between the running application programs and closes the data communication line according to the notification sent from the icon display control means 211 when the icon display control means 211 causes the symbols to be set to a non-display state.

For example, when a document file is moved onto the symbol by a drag-and-drop operation, an application for the file transfer is activated on the information processing apparatuses 21 and 22, and the document file is transferred from the information processing apparatus 21 to the information processing apparatus 22. Or, when a particular operation (for example, an operation in which a pop-up menu is displayed and an item is selected) is conducted for this symbol, a videoconference application is activated on the information processing apparatuses 21 and 22 to communicate video images. Also, in a situation wherein the call between the communication terminals 11 and 12 is terminated during the transfer of the document file from the information processing apparatus 21 to the information processing apparatus 22, it is also possible to perform control to terminate the file transferring application after the file transfer is completed. During the period of time in which the application program is running, it is possible that by issuing a notification from the AP control means 214 to the icon display control means 211, the symbol indicating that the application program is available is changed to a symbol (for example, an icon and a character string indicating the call peer exemplified in FIG. 6) indicating that the application program is being used, to thereby clearly notify the user of an event that the program is being used.

The information processing apparatus 22 includes icon display control means 221, an initializing information storage 222, correspondence information transmitting means 223, and AP control means 224. Outlines of these means are similar respectively to those of the icon display control means 211, the initializing information storage 212, the correspondence information transmitting means 213, and the AP control means 214 in the information processing apparatus 21.

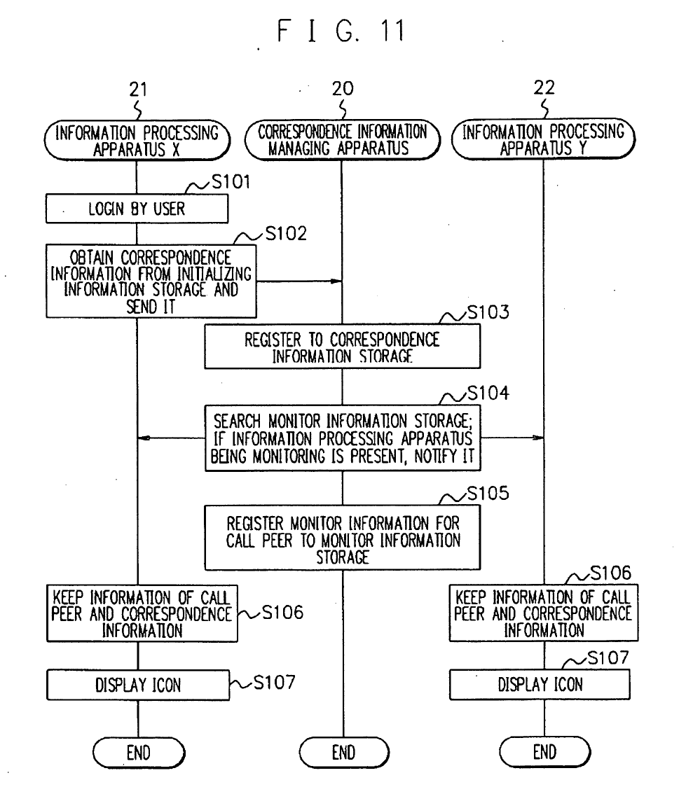

FIGS. 9 and 10 exemplify initializing information pieces stored in the initializing information storages 212 and 222, a private IC card, and the like.

For example, the example of FIG. 9 stores, as initializing information pieces, its own information processing apparatus ID “pc01@domain.com”, IDs “sip:user01@hostA.domain.com” and “sip:user03@hostA.domain.com” of communication terminals to be associated with the information processing apparatus, an ID “hostA.domain.com” of the call controller accommodating the communication terminals, corresponding display names “Taro (firm)” and “Taro (cellular)”, ranks “1” and “1” indicating priority when there exist a plurality of information processing apparatuses to be associated with one and the same communication terminal, and an ID “renkei@abc.com” of the correspondence information managing apparatus 20.

Furthermore, the example of FIG. 10 stores, as initializing information pieces, its own information processing apparatus ID “pc01a@domain.com”, an ID “sip:user01@hostA.domain.com” of a communication terminal to be associated therewith, an ID “hostA.domain.com” of the call controller accommodating the communication terminal, a corresponding display name “Taro (firm)”, rank “2” indicating priority when there exist a plurality of information processing apparatuses to be associated with one and the same communication terminal, and an ID “renkei@abc.com” of the correspondence information managing apparatus 20.

### Description of Operation of First Exemplary Embodiment

Next, description will be given in detail of operation of the exemplary embodiment.

### [Operation at Login]

First, description will be given of operation at login by use of an example in which the user, Mr. Taro of the communication terminal 11 logs in to the information processing apparatus 21. FIG. 11 is a sequence chart to explain the operation at login; first, Mr. Taro using the communication terminal 11 starts a login to the information processing apparatus 21 which is dedicated to the user or which is shared (step S101).

Next, if the information processing apparatus 21 is dedicated to Mr. Taro, the correspondence information transmitting means 213 acquires the initializing information exemplified in FIG. 9 from the initializing information storage 212 to send the information to the correspondence information managing apparatus 20 (step S102). Incidentally, if the information processing apparatus 21 is shared and private information pieces such as a communication terminal ID and a display name cannot be kept as initializing information in the initializing information storage 212, operation is conducted, for example, as follows. The user manually inputs private information such as a communication terminal ID at login from a keyboard or the like and the correspondence information transmitting means 213 transmits to the correspondence information managing apparatus 20 the private information such as a communication terminal ID manually inputted and an information processing apparatus ID registered to the initializing information storage 212. Also, the private information such as a communication terminal ID is kept in a private IC card (including a contactless IC card “FeliCa” mounted in a cellular); at login, the correspondence information transmitting means 213 transmits to the correspondence information managing apparatus 20 the private information such as a communication terminal ID read from the private IC card and an information processing apparatus ID registered to the initializing information storage 212. In addition, since the initializing information includes the correspondence information managing apparatus ID as shown in FIG. 9, the correspondence information transmitting means 213 can access the correspondence information managing apparatus 20 based on the apparatus ID. Furthermore, in step S102, in consideration of a case wherein the information sent to the correspondence information managing apparatus 20 includes the private information manually inputted or temporarily obtained from the IC card or the like, the information sent to the correspondence information managing apparatus 20 is kept as initializing information in a memory of the information processing apparatus 21.

Next, the correspondence information managing means 201 in the correspondence information managing apparatus 20 registers, based on the received information, the correspondence information exemplified in the first and third lines of FIG. 7 to the correspondence information storage 203 (step S103).

If the call is not being conducted between the communication terminals (communication terminals 11 and 12), the processing is terminated at this point.

On the other hand, if the call has already been started between the communication terminals (communication terminals 11 and 12), the correspondence information managing means 201 makes a check to determine whether or not monitor information including, as the monitor object communication terminal ID, the communication terminal ID of the communication terminal 11 being used for the call by Mr. Taro exists in the monitor information storage 206 (step S104). And if such monitor information has not been registered to the monitor information storage 206, the correspondence information managing means 201 registers to the monitor information storage 206 monitor information (monitor information of the first line of FIG. 8) in which the communication terminal ID of the communication terminal 12 being used by Ms. Hanako as the call peer is set as the monitor object communication terminal ID and the information processing apparatus ID of the information processing apparatus 21 to which Mr. Taro has conducted the login is set as the notification destination information processing apparatus ID (step S105).

In contrast thereto, if the monitor information including, as the monitor object communication terminal ID, the communication terminal ID of the communication terminal 11 being used for a call by Mr. Taro has been registered to the monitor information storage 206, the processing is executed in step S104 as follows. In this regard, the monitor information is monitor information which is registered when Ms. Hanako conducts a login to the information processing apparatus 22 associated with the communication terminal 12 of Ms. Hanako making a call with Mr. Taro or when Ms. Hanako starts the call and which includes the ID of the communication terminal 11 as the monitor object communication terminal ID and the ID of the information processing apparatus 22 as the notification destination information processing apparatus ID. Then, an availability notification including the correspondence information (the communication terminal IDs, IDs of information processing apparatuses, display names, and the like associated with those communication terminals) of the call peer is transmitted to the information processing apparatus 21 to which the login is just conducted and the information processing apparatus 22 monitoring the communication terminal 11 (step S104). Also, in order that the information processing apparatus 21 to which the login is just conducted monitors the communication terminal 12, the monitor information exemplified in the first line of FIG. 8 is registered to the monitor information storage 206 (step S105). This is monitor information required when the user (Ms. Hanako) logs out from the information processing apparatus 22 associated with the communication terminal 12.

Each of the information processing apparatuses 21 and 22 having received the availability notification including the correspondence information of the call peer keeps the contents thereof and uses the contents to perform data transfer to and from the information processing apparatus as the peer (step S106). In this case, since the information processing apparatuses 21 and 22 associated with both of the communication terminals 11 and 12 which are conducting a call are present, there is displayed a symbol indicating that the information processing apparatus of the call peer is available (step S107).

### [Operation at Call Initiation]

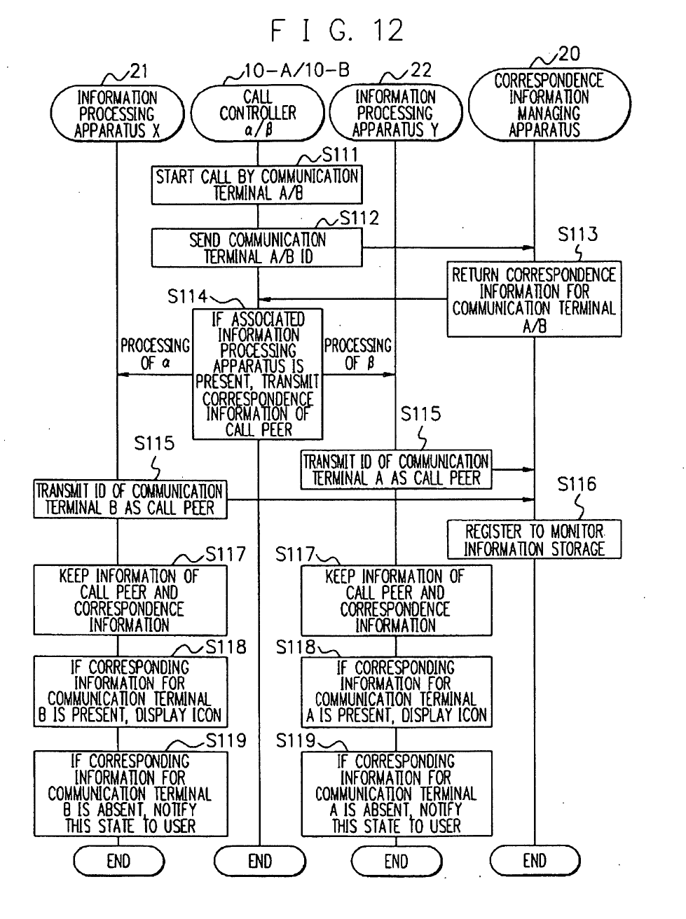

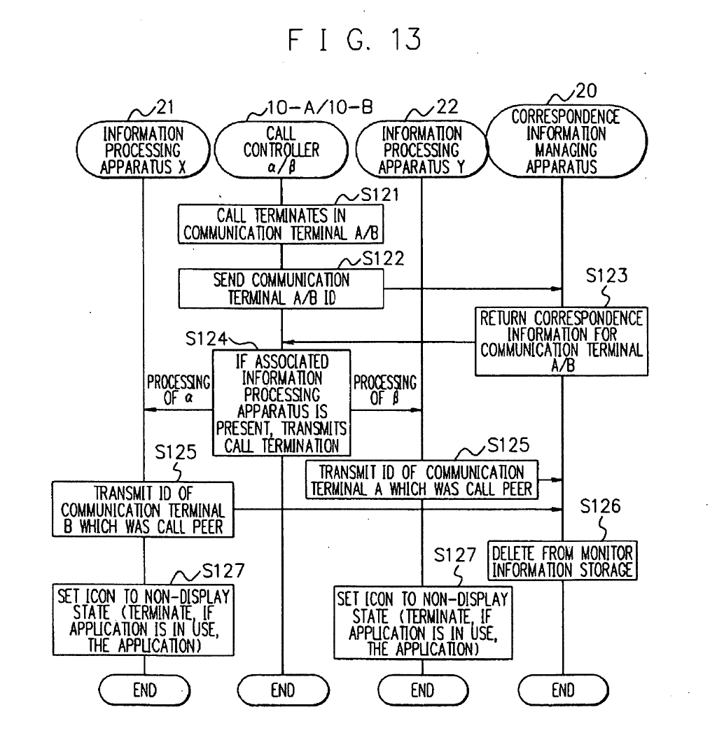

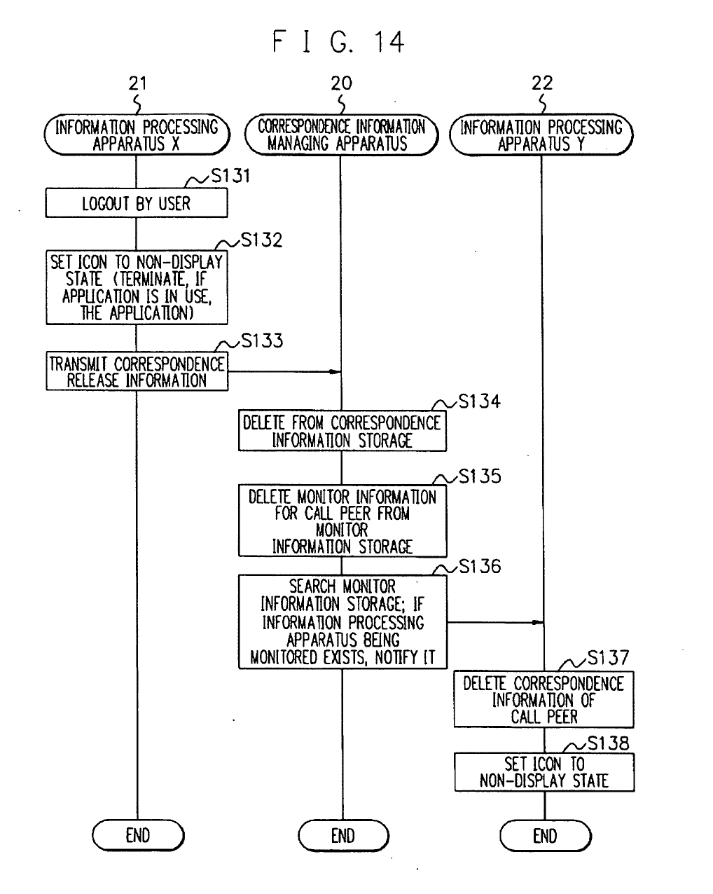

Subsequently, description will be given of operation when a call is initiated. FIG. 12 is a sequence chart in a situation wherein the user (Mr. Taro) of the information processing apparatus 21 conducts an operation for call initiation by use of the communication terminal 11 to start a call. First, the call controllers 10-A and 10-B detect an event in which a call has been initiated between the communication terminals (communication terminals 11 and 12; step S111). In the operation, any one of the call controllers 10-A and 10-B can detect the initiation of a call between the communication terminals 11 and 12.

Next, the terminal IDs of the communication terminals 11 and 12 conducting a call are sent to the correspondence information managing apparatus 20 (step S112). Assume here that the call controllers 10-A and 10-B beforehand know, by using the initializing information or the like, the correspondence information managing apparatus ID. The correspondence information managing apparatus 20 acquires, from the correspondence information storage 203 exemplified in FIG. 7, correspondence information associated with the communication terminal IDs of the communication terminals 11 and 12 received as above and returns the information (step S113). Incidentally, if there exists no correspondence information associated with the communication terminal IDs, information indicating the condition is returned.

The call controller 10-A having acquired the correspondence information transmits, if the information processing apparatus 21 has been associated with the communication terminal 11 (in other words, if the user, i.e., Mr. Taro has conducted the login to the information processing apparatus 21), the correspondence information (the communication terminal ID and the information processing apparatus ID, the display name, and the like associated therewith) of the communication terminal 12 as the call peer to the information processing apparatus 21. In this connection, if there does not exist correspondence information of the communication terminal 12, the condition is sent to the information processing apparatus 21. Similarly, the call controller 10-B having acquired the correspondence information transmits, if the information processing apparatus 22 has been associated with the communication terminal 12 (in other words, if the user, i.e., Ms. Hanako has conducted the login to the information processing apparatus 22), the correspondence information (the communication terminal ID and the information processing apparatus ID, the display name, and the like associated therewith) of the communication terminal 11 as the call peer to the information processing apparatus 22 (step S114). In this regard, if there does not exist correspondence information of the communication terminal 11, the condition is sent to the information processing apparatus 22. That is, if both of the correspondence information pieces of the communication terminals 11 and 12 conducting the call have been registered to the correspondence information storage 203, the correspondence information (which is a call available notification indicating availability of the information processor as the call peer) is sent to the information processing apparatuses 21 and 22.

The information processing apparatus 21 having received the correspondence information of the call peer (namely, the information processing apparatus to which Mr. Taro as the user has conducted the login) transmits, in order to monitor the correspondence state of the communication terminal 12 as the call peer, the communication terminal ID of the communication terminal 12 and its own information processing apparatus ID to the correspondence information managing apparatus 20. In a similar way, the information processing apparatus 22 having received the correspondence information of the call peer (namely, the information processing apparatus to which Ms. Hanako as the user has conducted the login) transmits, to monitor the correspondence state of the communication terminal 11 as the call peer, the communication terminal ID of the communication terminal 11 and its own information processing apparatus ID to the correspondence information managing apparatus 20 (step S115).

Next, the correspondence information managing apparatus 20 registers, according to the received information, the monitor information exemplified in FIG. 8 to the monitor information storage 206. As a result, the correspondence information managing apparatus 20 monitors the correspondence state of the communication terminal 12 to cope with a case wherein the user (Ms. Hanako) of the communication terminal 12 conducts a login to the information processing apparatus 22 associated with the communication terminal 12 or a logout therefrom. Similarly, the correspondence state of the communication terminal 11 is monitored and it is hence possible to cope with a case wherein the user (Mr. Taro) of the communication terminal 11 conducts a login to the information processing apparatus 21 associated with the communication terminal 11 or a logout therefrom (step S116).

Each of the information processing apparatuses 21 and 22 (namely, the information processing apparatuses to which the login has been conducted) having received the correspondence information of the call peer keeps the contents and uses the contents to conduct data transfer to and from the information processing apparatus as the call peer (step S117).

If the information processing apparatus associated with the call peer is present (that is, the user has conducted the login), a symbol indicating possibility of data transfer with the information processing apparatus as the call peer is displayed (step S118). Since it is obvious that the information processing apparatus associated with the own side is present, there exist the information processing apparatuses 21 and 22 available for both sides conducting the call, and it is judged that the data transfer is possible.

If the information processing apparatus associated with the call peer is absent (that is, the user has not conducted the login), the condition is notified to the user by a dialog or the like (step S119). It is possible that the user having viewed the notification notifies, by use of the communication terminal 11 conducting the call, the absence of the associated information processing apparatus to the call peer (Ms. Hanako), by using voice.

### [Operation at Call Termination]

FIG. 13 is a sequence chart in a situation wherein the user (Mr. Taro) of the information processing apparatus 21 has terminated the call conducted by use of the communication terminal 11. First, the call controllers 10-A and 10-B detect that a call has been terminated between the communication terminals (communication terminals 11 and 12; step S121). In the operation, each of the call controllers 10-A and 10-B can detect the termination of a call between the communication terminals 11 and 12.

Next, the communication terminal IDs of the communication terminals 11 and 12 which were conducting a call are sent to the correspondence information managing apparatus 20 (step S122). Assume here that the call controllers 10-A and 10-B beforehand know the correspondence information managing apparatus ID using the initializing information or the like. The correspondence information managing apparatus 20 acquires, from the correspondence information storage 203 exemplified in FIG. 7, correspondence information associated with the communication terminal IDs of the communication terminals 11 and 12 received as above and returns the information (step S123).

The call controller 10-A having acquired the correspondence information notifies, if the information processing apparatus 21 has been associated with the communication terminal 11 (that is, if the user, i.e., Mr. Taro has conducted the login to the information processing apparatus 21), the termination of the call to the information processing apparatus 21. On the other hand, the call controller 10-B having acquired the correspondence information notifies, if the information processing apparatus 22 has been associated with the communication terminal 12 (in other words, if the user, i.e., Ms. Hanako has conducted the login to the information processing apparatus 22), the termination of the call to the information processing apparatus 22 (step S124).

The information processing apparatus 21 having received the termination of the call (namely, the information processing apparatus to which Mr. Taro as the user has conducted the login) transmits, in order to release the monitoring of the correspondence state with respect to the communication terminal 12 as the call peer, the communication terminal ID of the communication terminal 12 and its own information processing apparatus ID to the correspondence information managing apparatus 20. In a similar way, the information processing apparatus 22 having received the termination of the call (namely, the information processing apparatus to which Ms. Hanako as the user has conducted the login) transmits, to release the monitoring of the correspondence state with respect to the communication terminal 11 as the call peer, the communication terminal ID of the communication terminal 11 and its own information processing apparatus ID to the correspondence information managing apparatus 20 (step S125).

Next, the correspondence information managing apparatus 20 deletes, according to the received information, the monitor information exemplified in FIG. 8 from the monitor information storage 206 (step S126).

Each of the information processing apparatuses 21 and 22 having received the termination of the call (i.e., the information processing apparatuses to which the login has been conducted) sets the symbol indicating that the information processing apparatus of the call peer is available, to a non-display state (step S127).

### [Operation at Logout]

FIG. 14 is a sequence chart in a situation wherein the user (Mr. Taro) of the communication terminal 11 has conducted a logout from the information processing apparatus 21. First, the user (Mr. Taro) of the communication terminal 11 starts a logout from the information processing apparatus 21 which is dedicated to the user or which is shared (step S131).

Next, if a symbol indicating availability of the information processing apparatus of the call peer is being displayed, the symbol is set to a non-display state (step S132).

Subsequently, the correspondence release information including the initializing information kept in the memory of the information processing apparatus 21 at login is transmitted to the correspondence information managing apparatus 20 (step S133). Since the correspondence information managing apparatus ID is contained in the initializing information, the information processing apparatus can access the correspondence information managing apparatus 20.

Then, the correspondence information managing apparatus 20 deletes, based on the received information, the correspondence information exemplified in first and third lines of FIG. 7 from the correspondence information storage 203 (step S134). If any call is not being conducted between the communication terminals (the communication terminals 11 and 12), the processing is terminated at this point.

On the other hand, if the call is being conducted between the communication terminals (the communication terminals 11 and 12), to first release the monitoring of the communication terminal 12 by the information processing apparatus 21 for which the user (Mr. Taro) has conducted the logout, the monitor information exemplified in FIG. 8 is deleted from the monitor information storage 206 (step S135). Incidentally, the information processing apparatus 22 is still monitoring the communication terminal 11. Hence, correspondence information indicating absence of the information processing apparatus as the call peer is sent to the information processing apparatus 22 conducting the monitoring (step S136).

The information processing apparatus 22 having received the correspondence information of the call peer, deletes the correspondence information of the call peer kept therein (step S137). In this case, since the information processing apparatus 21 associated with the call peer becomes absent, the symbol indicating availability of the information processing apparatus as the call peer is set to a non-display state (step S138).

### Advantage of First Exemplary Embodiment

In accordance with the exemplary embodiment, only though conducting a call issuing operation by use of a communication terminal, at least the call issuer or a call receiver is capable of knowing whether or not the information processing apparatus of the call peer is available. This is because the exemplary embodiment includes the correspondence information storage 203 to which correspondence information establishing a correspondence between an information processing apparatus in an available state and a communication terminal is registered, the correspondence information retrieval means 202 to retrieve from the correspondence information storage 203 the correspondence information regarding the call-issuing side communication terminal 11 and the call-termination side communication terminal 12 detected by the call control means 111, and the call information transmitting means 114 to transmit, when the correspondence information retrieval means 202 retrieves the correspondence information regarding the call-issuing side communication terminal 11 and the call-termination side communication terminal 12, an availability notification indicating availability of the information processing apparatus of the call peer to at least one information processing apparatus selected from the information processing apparatuses including the information processing apparatus associated with the call-issuing side communication terminal 11 and the information processing apparatus 22 associated with the call-termination side communication terminal 12.

Additionally, according to the exemplary embodiment, each of the information processing apparatuses 21 and 22 includes the icon display control means 211 to display, when the availability notification is received, a symbol indicating that the information processing apparatus of the call peer is in an available state; hence, the user can instantaneously recognize that the information processing apparatus of the call peer is in an available state. Furthermore, since the symbol includes a display name of the call peer, even if calls are simultaneously conducted with a plurality of persons by use of a plurality of communication terminals, it is possible to immediately judge which one of the symbols belong to which one of the calls.

In addition, the exemplary embodiment includes the AP control means 214 and 224 to activate, when a symbol is operated, an application program to conduct data transfer between the information processing apparatuses 22 and 21 associated with the communication terminals 12 and 11 of the call peers, and hence usability can be increased. For example, when a drag-and-drop is conducted for a document file to move the file onto the symbol, the application for the file transfer is activated on the information processing apparatuses 21 and 22 to open a data communication line between the apparatuses 21 and 22, and the document file is transferred to the information processing apparatus associated with the communication terminal as the call peer, which provides the user with an instinctive operation feeling and hence increases usability.

Further, when an information processing apparatus associated with a call peer is additionally installed (namely, a login is conducted for the apparatus) or is deleted (namely, a logout is conducted for the apparatus) from the correspondence information managing apparatus 20 to the information processing apparatuses 21 and 22, the condition is notified; hence, it is possible, when a new login is conducted, to display on a screen of the information managing apparatus a symbol indicating that the information managing apparatus of the call peer is available and it is possible, when a logout is conducted, to set the symbol in a non-display state.

Also, between the call controllers 10-A and 10-B, only call information and audio information are communicated and other data is not directly communicated; therefore, even in a situation wherein the call controllers 10-A and 10-B are connected via Private Branch eXchanges (PBX) of different firms to intranets of the respective firms, if each PBX includes call information analyzing means and call information transmitting means and a correspondence information managing apparatus is disposed on the internet connectible to both PBXs, the operation can be carried out without modifying the existing communication network and the information processing network. However, when data transfer is conducted between the information processing apparatuses connected to the intranets of the different firms, the data transfer may be prevented due to intervention of a Network Address Translation (NAT) or a firewall; however, this may be solved by use of a technique disclosed in, for example, Japanese Patent Laid-Open Publication No. 2001-86163.

### Second Exemplary Embodiment

Next, description will be given in detail of a second exemplary embodiment of the present invention by referring to the drawings. While description has been given of the use of information processing apparatuses for a call between two persons in conjunction with the first exemplary embodiment, description will now be given of the use of information processing apparatuses for a call among three persons or more.

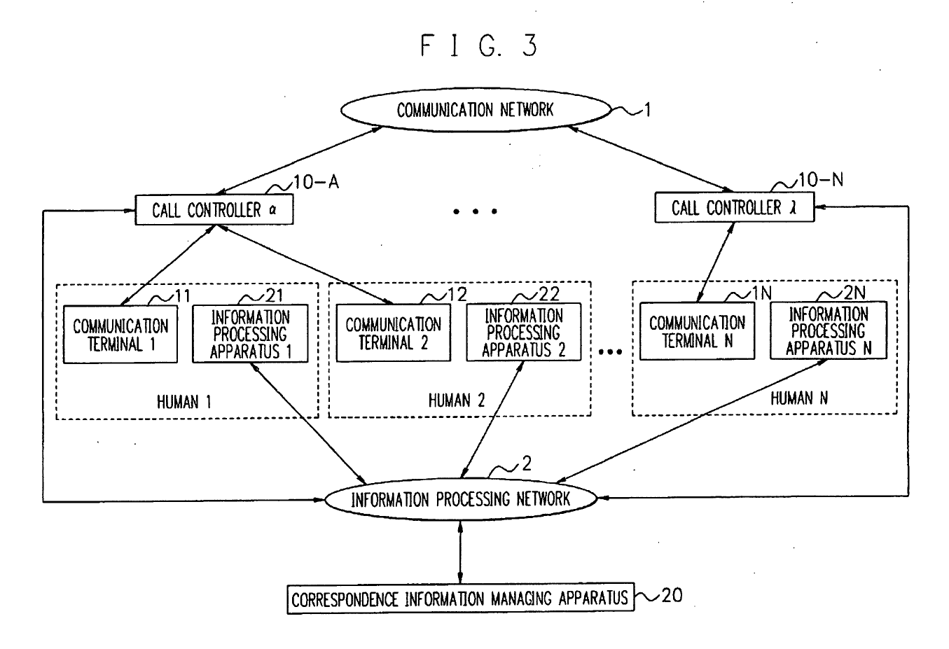

Referring to FIG. 3, the second exemplary embodiment of the present invention includes a communication network 1, a plurality of call controllers including call controllers 10-A and 10-N connected to the communication network 1, a plurality of communication terminals including communication terminals 11 and 12 coupled with the call controller 10-A, a plurality of communication terminals including communication terminal 1N link with the call controller 10-N, an information processing network 2, and a plurality of information processing apparatuses including information processing apparatuses 21, 22, and 2N and a correspondence information managing apparatus 20 which are connected to the information processing network 2. The communication network 1 is in general a circuit switched network, but may be recently a VoIP network employing such as a Session Initiation Protocol (SIP). Further, the information processing network 2 is in general an intranet in a firm or the Internet.

The communication terminal 11 and the information processing apparatus 21 are used by one and the same user and it is indicated that a correspondence is established between the communication terminal and the information processing apparatus according to the present invention. Similarly, the communication terminal 12 and the information processing apparatus 22 are used by one and the same user and it is indicated that a correspondence is established between the communication terminal and the information processing apparatus in accordance with the present invention. In addition, the communication terminal 1N and the information processing apparatus 2N are used by one and the same user and it is indicated that a correspondence is established between the communication terminal and the information processing apparatus according to the present invention. The correspondence between the communication terminal and the information processing apparatus above applies also to a case wherein the communication terminal and the information processing apparatus are shared and are temporarily used by one and the same user.

In the description, the diagram showing details of the constituent components of FIG. 3 is equivalent to FIG. 4.

Subsequently, referring to a sequence chart, description will be given in detail of the overall operation of the exemplary embodiment.

### [Operation at Login]

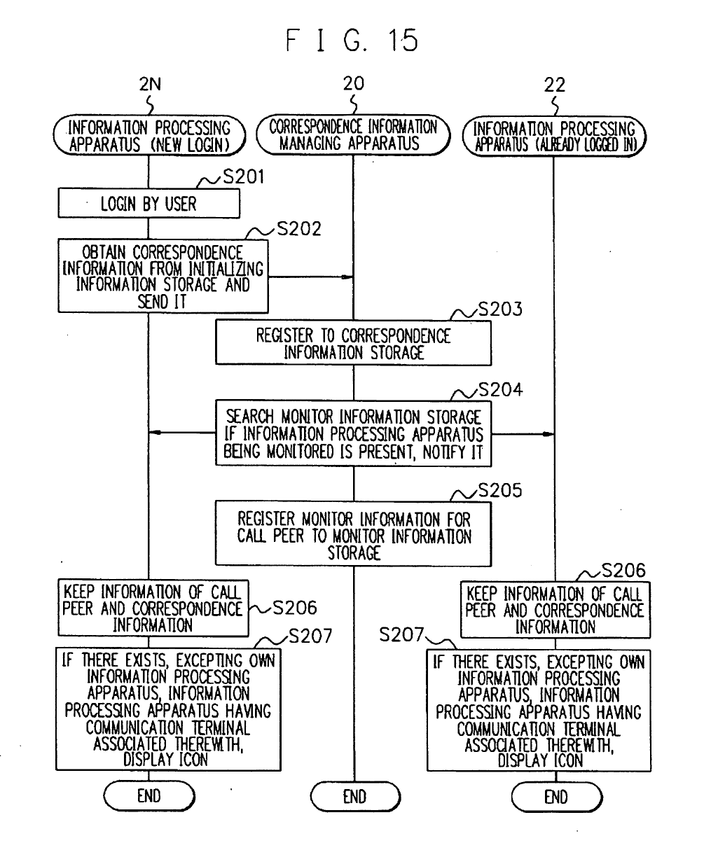

FIG. 15 is a sequence chart in a situation wherein a user of the communication terminal 1N conducts a login to the information processing apparatus 2N.

First, the user of the communication terminal 1N starts the login to the information processing apparatus 2N which is dedicated to the user or which is shared (step S201).

Next, if the information processing apparatus 2N is dedicated to the user, the initializing information exemplified in FIG. 9 is obtained from the initializing information storage 212 to be sent to the correspondence information managing apparatus 20 (step S202). In this regard, if the information processing apparatus 2N is shared and private information pieces such as a communication terminal ID and a display name cannot be kept as initializing information in the initializing information storage 212, operation is conducted, for example, as follows. The user manually inputs private information such as a communication terminal ID at login from a keyboard or the like and the correspondence information transmitting means 213 transmits to the correspondence information managing apparatus 20 the private information such as a communication terminal ID manually inputted and an information processing apparatus ID registered to the initializing information storage 212. Also, the private information such as a communication terminal ID is kept in a private IC card (including a contactless IC card “FeliCa” mounted in a cellular); at login, the correspondence information transmitting means 213 transmits to the correspondence information managing apparatus 20 the private information such as a communication terminal ID read from the private IC card and an information processing apparatus ID registered to the initializing information storage 212. In addition, since the initializing information includes the correspondence information managing apparatus ID as shown in FIG. 9, the correspondence information transmitting means 213 can access the correspondence information managing apparatus 20 based on the managing apparatus ID. Furthermore, in step S202, in consideration of a case wherein the information sent to the correspondence information managing apparatus 20 includes the private information manually inputted or temporarily obtained from the private IC card or the like, the information sent to the correspondence information managing apparatus 20 is kept as initializing information in a memory of the information processing apparatus 21.

Next, the correspondence information managing apparatus 20 registers, based on the received information, the correspondence information exemplified in FIG. 7 to the correspondence information storage 203 (step S203). If the call is not being executed between the communication terminals (between the communication terminals 1N and one or more other communication terminals), the processing is terminated at this point.

On the other hand, if the call has already been started between the communication terminals (between the communication terminals 1N and one or more other communication terminals), a check is made by searching the monitor information storage 206 to determine whether or not at least one other information processing apparatus is monitoring the communication terminal 1N (step S204). And if such information processing apparatus is absent, in order that the information processing apparatus 2N monitors other communication terminals being conducting a call with the communication terminal 1N, the monitor information exemplified in FIG. 8 is registered to the monitor information storage 206 (step S205).

In contrast thereto, if an information processing apparatus monitoring the communication terminal 1N is present, processing is executed as follows. In the operation, the monitor information as a factor to judge that an information processing apparatus monitoring the communication terminal 1N is present is registered when the user conducts the login or starts the call for an information processing apparatus associated with another communication terminal. Hence, correspondence information (a communication terminal ID and an information processing apparatus ID, a display name, and the like associated with the communication terminal ID) of the call peer is transmitted to the information processing apparatus 2N associated with the communication terminal 1N and at least one information processing apparatus conducting the monitoring (step S204).

Also, for the information processing apparatus 2N to monitor at least one other communication terminal being conducting a call with the communication terminal 1N, the monitor information exemplified in FIG. 8 is registered to the monitor information storage 206 (step S205). This is monitor information required when the user conducts a logout from the information processing apparatus associated with at least one other communication terminal.

Each of the information processing apparatus 2N and the at least one other information processing apparatuses which has received the correspondence information of the call peer keeps the contents of the information and uses the contents to conduct data transfer with the information processing apparatus of the call peer (step S206). Moreover, if there exists, in addition to the own information processing apparatus, an information processing apparatus having an associated communication terminal which is conducting a call, a symbol indicating availability of the information processing apparatus of the call peer is displayed (S207).

### [Operation to Participate in Existing Call]

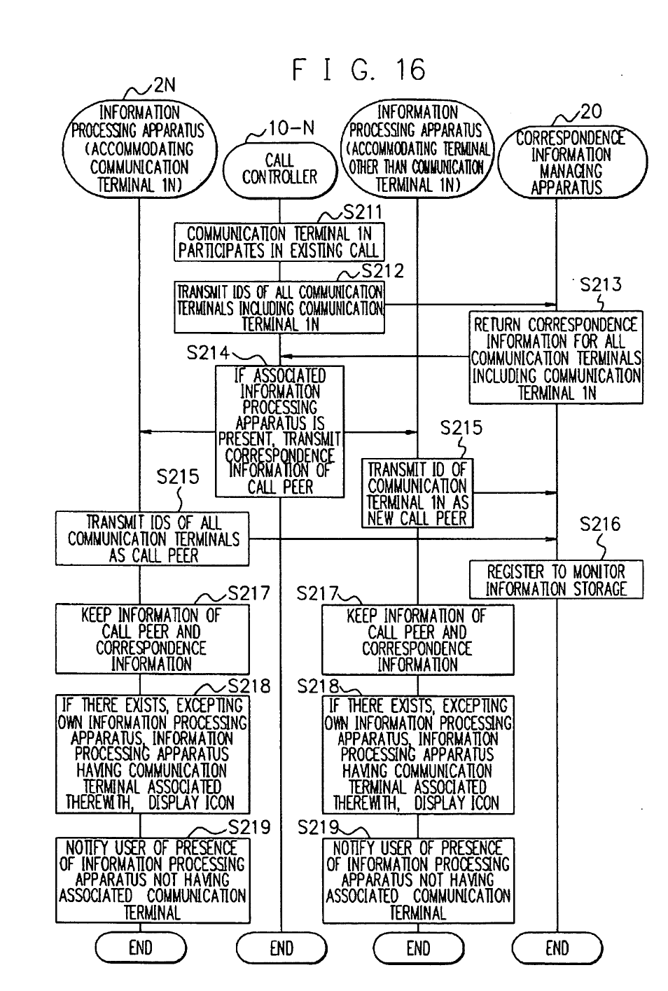

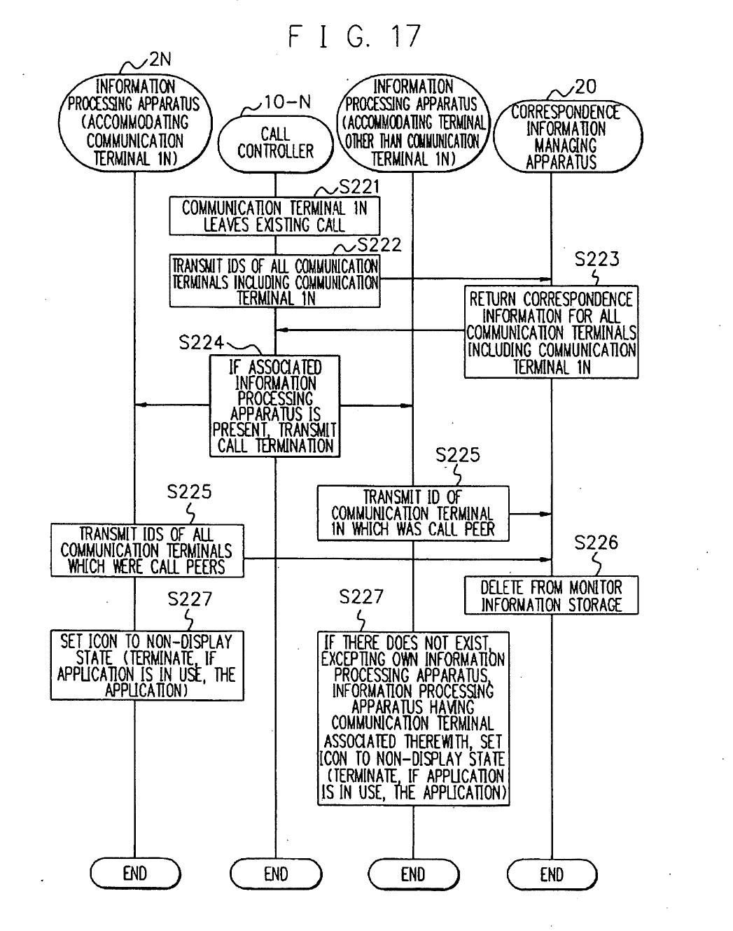

FIG. 16 is a sequence chart in a situation wherein the user of the information processing apparatus 2N participates, by use of the associated communication terminal 1N, in an existing call. In this regard, even the call is started among three or more persons, it can be assumed that a person participates in a call locally between at least two persons individually. Further, even when a call is transferred from a first communication terminal to a second communication terminal, it can be assumed that this is locally equivalent to participation of the second terminal and withdrawal of the first communication terminal.

First, each call controller accommodating a communication terminal having already participated in a conversation with the call controller 10-N accommodating the communication terminal 1N detects the event that the new communication terminal 1N has participated in the existing call (step S211). Here, any one of the call controllers is capable of detecting the event that the new communication terminal 1N has participated in the existing call.

Next, each call controller transmits, to the correspondence information managing apparatus 20, the communication terminal IDs of all communication terminals being conducting the call and the communication terminal ID of the communication terminal 1N having additionally participated in the call (step S212). In this regard, it is assumed that each call controller has beforehand known the correspondence information managing apparatus ID using the initializing information or the like. The correspondence information managing apparatus 20 attains, from the correspondence information storage 203 exemplified in FIG. 7, the correspondence information associated with the received communication terminal, IDs of all communication terminals and then returns the information (S213). Incidentally, if the correspondence information associated with any communication terminal ID is absent, information indicating this condition is returned.

The call controller 10-N having acquired the correspondence information transmits, if the information processing apparatus 2N is associated with the communication terminal 1N (namely, if the user has conducted a login to the information processing apparatus 2N), the correspondence information (the communication terminal ID and the information processing apparatus ID, the display name, and the like associated therewith) of each communication terminal as a call peer to the information processing apparatus 2N. In this connection, if the correspondence information of each communication terminal as a call peer is absent, the condition is notified to the information processing apparatus 2N. On the other hand, any other call controller (the call controller accommodating a communication terminal having already participated in the conversation) having acquired the correspondence information transmits, if the information processing apparatus is associated with the communication terminal (in other words, if the user having already participated in the conversation has conducted a login to the information processing apparatus), the correspondence information (the communication terminal ID and the information processing apparatus ID, the display name, and the like associated therewith) of the communication terminal 1N as a call peer to the information processing apparatus 2N (step S214). In this regard, if the correspondence information of the communication terminal as the call peer is absent, the condition is notified to the information processing apparatus. That is, the correspondence information of the communication terminal 1N having participated in the call is registered to the correspondence information storage 203; if the correspondence information of the communication terminals having already participated in the call has been registered to the correspondence information storage 203, the correspondence information of the call peer (a call availability notification indicating availability of the information processing apparatus of the call peer) is sent to each information processing apparatus 21.

The information processing apparatus 2N having received the correspondence information of the call peer (namely, the information processing apparatus to which the user has conducted the login) transmits, to monitor the correspondence state of the other communication terminals as call peers, the communication terminal IDs of the other communication terminals and its own information processing apparatus ID to the correspondence information managing apparatus 20. Similarly, any other information processing apparatus having received the correspondence information of the communication terminal 1N (namely, each information processing apparatus which is associated with a communication terminal having already participated in the conversation and to which the user has conducted the login) transmits, to monitor the correspondence state of the communication terminal 1N as a new call peer, the communication terminal ID of the communication terminal 1N and its own information processing apparatus ID to the correspondence information managing apparatus 20 (step S215).

Subsequently, the correspondence information managing apparatus 20 registers, based on the received information, the monitor information exemplified in FIG. 8 to the monitor information storage 206. As a result, the correspondence information managing apparatus 20 monitors the correspondence state of the communication terminal 1N, and it is possible to cope with a case wherein the user of the communication terminal for which a login has not been conducted conducts a login to the information processing apparatus associated with the communication terminal or a logout therefrom (step S216).

Each of the information processing apparatus 2N having received the correspondence information of the call peer and the other at least one information processing apparatus keeps the contents of the information and uses the contents when data transfer is conducted with an information processing apparatus as a call peer (step S217). Also, if there exists, in addition to the own information processing apparatus, an information processing apparatus having an associated communication terminal which is conducting a call, a symbol indicating availability of the information processing apparatus of the call peer is displayed (S218).

If the information processing apparatus associated with the call peer is absent, the condition is notified to the user by a dialog or the like (step S219). It is possible that the user having viewed the notification notifies, by use of the communication terminal conducting the call, the absence of the available information processing apparatus to the call peer by using voice.

[Operation at Withdrawal from Call]

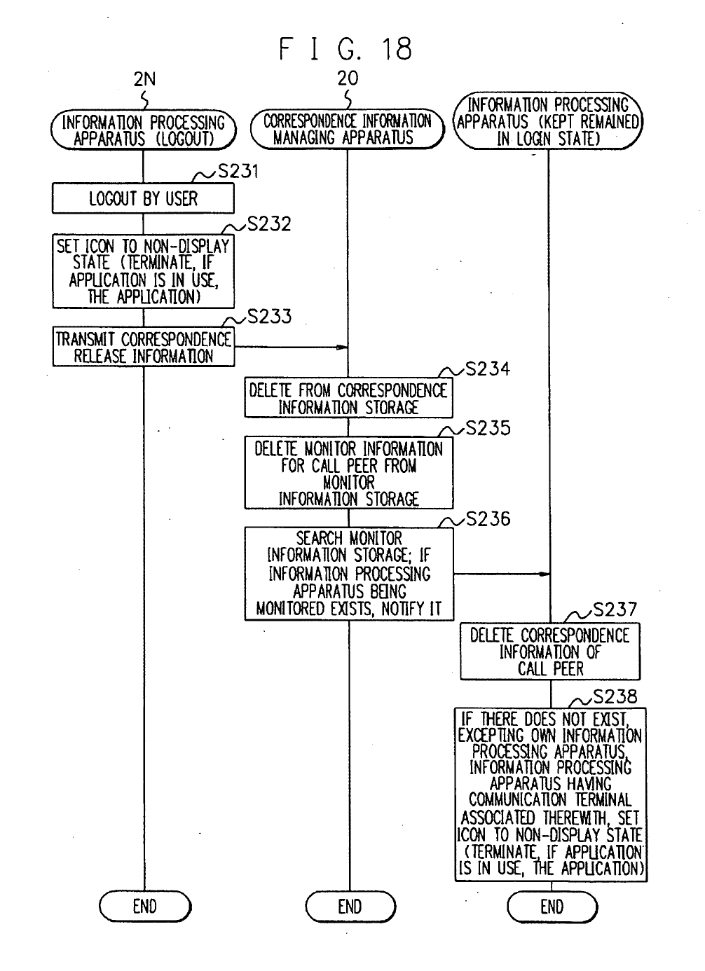

FIG. 17 is a sequence chart in a situation wherein the user of the information processing apparatus 2N withdraws from the call which is conducted by use of the communication terminal 1N (only the communication terminal 1N terminates the call). Here, even the call is terminated among three or more persons, it can be assumed that the person withdraws from the call locally between at least two persons individually. First, each call controller accommodating a communication terminal having already participated in a conversation and the call controller 10-N accommodating the communication terminal 1N detects the event that the new communication terminal 1N has withdrawn from the call (step S221). in the operation, any one of the call controllers is capable of detecting the event that the communication terminal 1N has withdrawn from the call.

Next, each call controller transmits, to the correspondence information managing apparatus 20, the communication terminal IDs of all communication terminals being conducting the call and the ID of the communication terminal 1N having withdrawn from the call (step S222). In this regard, it is assumed that each call controller has beforehand known the correspondence information managing apparatus ID using the initializing information or the like. The correspondence information managing apparatus 20 attains, from the correspondence information exemplified in FIG. 7, the correspondence information associated with the received communication terminal IDs of all communication terminals and then returns the information (S223).

The call controller 10-N having acquired the correspondence information notifies, if the information processing apparatus 2N is associated with the communication terminal 1N (namely, if the user has conducted a login to the information processing apparatus 2N), the termination of the call to the information processing apparatus 2N. Any other call controller (the call controller accommodating a communication terminal still participating in the conversation) having acquired the correspondence information notifies, if the information processing apparatus is associated with the communication terminal (in other words, if the user has conducted a login to the information processing apparatus), the withdrawal of the communication terminal 1N which was the call peer from the call to the information processing apparatus (step S224).

The information processing apparatus 2N having received the termination of the call (namely, the information processing apparatus to which the user has conducted the login) transmits, to release the monitoring of the correspondence state of the other communication terminals as call peers, the communication terminal IDs of the other communication terminals and its own information processing apparatus ID to the correspondence information managing apparatus 20. Similarly, any other information processing apparatus having received the termination of the call of the communication terminal 1N (namely, each information processing apparatus which is associated with a communication terminal still participating in the conversation and to which the user has conducted the login) transmits, to release the monitoring of the correspondence state of the communication terminal 1N as the call peer, the communication terminal ID of the communication terminal 1N and its own information processing apparatus ID to the correspondence information managing apparatus 20 (step S225).

Subsequently, the correspondence information managing apparatus 20 deletes, based on the received information, the monitor information exemplified in FIG. 8 from the monitor information storage 206 (step S226). The information processing apparatus 2N having received the termination of the call of the communication terminal 1N sets, if a symbol indicating possibility of data transfer with the information processing apparatus as the call peer is being displayed, the symbol to a non-display state. Additionally, at least one information processing apparatus having received the termination of the call of the communication terminal 1N sets; if there does not exist, excepting the own information processing apparatus, any information processing apparatus having a communication terminal which is associated therewith and which is conducting a call; the symbol indicating possibility of data transfer with the information processing apparatus as the call peer to a non-display state (step S227).

### [Operation at Logout]

FIG. 18 is a sequence chart in a situation wherein the user of the communication terminal 1N has conducted a logout from the information processing apparatus 2N. First, the user of the communication terminal 1N starts a logout from the information processing apparatus 2N which is dedicated to the user or which is shared (step S231).

Next, if a symbol indicating availability of the information processing apparatus of the call peer is being displayed, the symbol is set to a non-display state (step S232).

Subsequently, the correspondence release information, which is transmitted to the correspondence information managing apparatus 20 at login and which includes the initializing information kept in the memory of the information processing apparatus 2N, is transmitted to the correspondence information managing apparatus 20 (step S233). Since the correspondence information managing apparatus ID is contained in the initializing information, the information processing apparatus 2N can access the correspondence information managing apparatus 20.

Thereafter, the correspondence information managing apparatus 20 deletes, based on the received information, the correspondence information exemplified in FIG. 7 from the correspondence information storage 203 (step S234). If any call is not being conducted between the communication terminals (the communication terminal 1N and at least one other communication terminal), the processing is terminated at this point.

On the other hand, if the call is still being conducted between the communication terminals (the communication terminal 1N and at least one other communication terminal), in order to first release the monitoring of the communication terminals conducting the call by the information processing apparatus 2N from which the user has conducted the logout, the monitor information exemplified in FIG. 8 is deleted from the monitor information storage 206 (step S235).

Incidentally, any other information processing apparatus associated with the communication terminal conducting a call is still monitoring the communication terminal 1N. Hence, absence of the correspondence information of the communication terminal 1N of the call peer is sent to the information processing apparatus conducting the monitoring (step S236).

The information processing apparatus 2N having received the correspondence information of the call peer deletes the correspondence information of the pertinent call peer kept therein (step S237). Also, if there does not exist, excepting the own information processing apparatus, the information processing apparatus having a communication terminal which is conducting a call and which is associated therewith, the symbol indicating availability of the information processing apparatus of the call peer is set to a non-display state (step S238).

### Advantage of Second Exemplary Embodiment

In accordance the exemplary embodiment, in addition to the advantage of the first exemplary embodiment, there is obtained an advantage in which the present invention is applicable also to a call mode such as a teleconference among many persons, and it is possible to provide a comfortable communication environment wherein, for example, audio transfer and data transfer are used in a remote teleconference or the like. This is because the participating communication terminal 1N having participated in a call being conducted by communication terminals conducting a call is detected by the call control means 111 and 121; the correspondence information retrieval means 202 retrieves from the correspondence information storage 203 the correspondence information related to the participating communication terminal 1N detected by the call controllers 111 and 121 and the communication terminals conducting a call; and each of the call information transmitting means 114 and 124 transmits, if the correspondence information retrieval means 202 retrieves the correspondence information of the participating communication terminal 1N and the correspondence information related to at least one of the communication terminals conducting a call, an availability notification indicating availability of the information processing apparatus of the call peer to the information processing apparatus 2N associated with the participating communication terminal 1N.

This application is based upon and claims the benefit of priority from Japanese patent application No. 2006-270560, filed on Oct. 2, 2006, the disclosure of which is incorporated herein in its entirety by reference.

### INDUSTRIAL APPLICABILITY

The present invention is applicable to a case wherein while conducting a call using a communication terminal such as a fixed telephone or a cellular, data transfer is conducted with a call peer by use of an information processing apparatus such as a personal computer.

### BRIEF DESCRIPTION OF DRAWINGS

[FIG. 1] is a block diagram showing an overall configuration example of a first exemplary embodiment of a communication support system according to the present invention.

[FIG. 2] is a block diagram showing a simplified configuration of the configuration of FIG. 1.

[FIG. 3] is a block diagram showing an overall configuration example of a second exemplary embodiment of a communication support system according to the present invention.

[FIG. 4] is a block diagram showing a configuration example of the call controllers 10-A and 10-B, the information processing apparatuses 21 and 22, and the correspondence information managing apparatus 20.

[FIG. 5] is a diagram showing an example of a symbol indicating availability of an information processing apparatus of a call peer.

[FIG. 6] is a diagram showing an example of a symbol indicating that data transfer is being conducted with an information processing apparatus of a call peer.

[FIG. 7] is a diagram showing a content example of the correspondence information storage 203.

[FIG. 8] is a diagram showing a content example of the monitor information storage 206.

[FIG. 9] is a diagram showing an example of the initializing information.

[FIG. 10] is a diagram showing another example of the initializing information.

[FIG. 11] is a sequence chart showing an operation example at login in the first exemplary embodiment of the present invention.

[FIG. 12] is a sequence chart showing an operation example at call initiation in the first exemplary embodiment of the present invention.

[FIG. 13] is a sequence chart showing an operation example at call termination in the first exemplary embodiment of the present invention.

[FIG. 14] is a sequence chart showing an operation example at logout in the first exemplary embodiment of the present invention.

[FIG. 15] is a sequence chart showing an operation example at login in the second exemplary embodiment of the present invention.

[FIG. 16] is a sequence chart showing an operation example at call initiation in the second exemplary embodiment of the present invention.

[FIG. 17] is a sequence chart showing an operation example at call termination in the second exemplary embodiment of the present invention.

[FIG. 18] is a sequence chart showing an operation example at logout in the second exemplary embodiment of the present invention.

### DESCRIPTION OF REFERENCE NUMERALS

1 Communication network (leased communication line, VoIP, etc.)
2 Information processing network (intranet, internet, etc.)
10, 10-A, 10-B, 10-N . . . Call controller (intra-office exchange, private branch exchange, SIP proxy, etc.)
111, 121 Call control means
112, 122 Call information storage
113, 123 Call information analyzing means
114, 124 Call information transmitting means
11, 12, 1N Communication terminal
21, 22, 2N Information processing apparatus
211, 221 Icon display control means
212, 222 Initializing information storage
213, 223 Correspondence information transmitting means
214, 224 Application Program (AP) control means
20 Correspondence information managing apparatus
201 Correspondence information managing means
202 Correspondence information retrieval means
203 Correspondence information storage
204 Monitor information managing means
205 Monitor information transmitting means
206 Monitor information storage

1. A communication support system, comprising:
a correspondence information storage to which correspondence information establishing a correspondence between an information processing apparatus in an available state and a communication terminal is registered;
a detecting unit which detects a call-issuing-side communication terminal and a call-termination-side communication terminal;
a retrieval unit which retrieves, from the correspondence information storage, correspondence information related to the call-issuing-side and call-termination-side communication terminals detected by the detecting unit; and
a notifying unit which transmits, when the retrieval unit retrieves the correspondence information related to the call-issuing-side and call-termination-side communication terminals, an availability notification indicating availability of an information processing apparatus of a call peer to at least one information processing apparatus selected from an information processing apparatus associated with the call-issuing-side communication terminal and an information processing apparatus associated with the call-termination-side communication terminal.

2. The communication support system according to claim 1, wherein:
the correspondence information storage and the retrieval unit are disposed in a correspondence information managing apparatus; and
the detecting unit and the notifying unit are disposed in a call controller.

3. The communication support system according to claim 1, comprising a managing unit which registers, in a situation wherein at login of the information processing apparatus, correspondence information establishing a correspondence between the information processing apparatus and a communication terminal is received from the information processing apparatus, the correspondence information to the correspondence information storage.

4. The communication support system according to claim 1, wherein the information processing apparatus comprises a display controlling unit which displays, when an availability notification is received, a symbol indicating availability of an information processing apparatus of a call peer.

5. The communication support system according to claim 4, wherein the information processing apparatus comprises an application program controlling unit which activates, when the symbol is operated, an application program to conduct data transfer with an information processing apparatus associated with a communication terminal of a call peer.

6. The communication support system according to claim 4, wherein the symbol comprises a display name of a call peer.

7. The communication support system according to claim 4, wherein:
the detecting unit detects termination of the call conducted between the call issuing-side and call-termination-side communication terminals;
the retrieval unit retrieves, from the correspondence information storage, correspondence information related to the call issuing-side and call-termination-side communication terminals the call termination of which is detected by the detecting unit;
the notifying unit transmits a call termination notification to an information processing apparatus for which the correspondence information is detected by the retrieval unit; and
the display controlling unit sets, when the call termination notification is received, the symbol to a non-display state.

8. The communication support system according to claim 3, comprising a monitoring unit which monitors;
in a situation wherein while the call issuing-side and call-termination-side communication terminals detected by the detecting unit are conducting a call, the correspondence information related to the call issuing-side and call-termination-side communication terminals is registered to the correspondence information storage; an availability notification indicating availability of an information processing apparatus of a call peer to at least one information processing apparatus selected from an information processing apparatus associated with the call-issuing-side communication terminal and an information processing apparatus associated with the call-termination-side communication terminal.

9. The communication support system according to claim 8, wherein the retrieval unit deletes; when a release notification is received from an information processing apparatus, the notification indicating release of the correspondence between the information processing apparatus and a communication terminal; the correspondence information which is registered to the correspondence information storage and which is related to the information processing apparatus, and transmits an availability notification to an information processing apparatus associated with a communication terminal conducting a call with the communication terminal.

10. The communication support system according to claim 1, wherein:
the detecting unit detects a participation communication terminal having participated in a call being conducted between in-call communication terminals which are conducting a call;
the retrieval unit retrieves, from the correspondence information storage, correspondence information related to the participation communication terminal and the in-call communication terminals; and
the notifying unit transmits an availability notification, when the retrieval unit detects correspondence information related to the participation communication terminal and correspondence information related at least to one of the in-call communication terminals, to an information processing apparatus associated with the participation communication terminal.

11. A correspondence information managing apparatus, comprising:
a correspondence information storage to which correspondence information establishing a correspondence between an information processing apparatus in an available state and a communication terminal is registered; and
a retrieval unit which inputs, from an external device, information of a call-issuing-side communication terminal and a call-termination-side communication terminal between which a call is being conducted; retrieves, from the correspondence information storage, correspondence information related to the call-issuing-side and call-termination-side communication terminals; and returns the correspondence information.

12. The correspondence information managing apparatus according to claim 11, wherein the retrieval unit inputs, from the external device, information of all communication terminals participating in a call; retrieves, from the correspondence information storage, correspondence information related to all of the communication terminals participating in the call; and returns the correspondence information.

13. An information processing apparatus, comprising a display controlling unit which displays a symbol indicating availability of an information processing apparatus of a call peer in a situation wherein under condition that both of correspondence information pieces related to a call-issuing-side communication terminal and a call-termination-side communication terminal between which a call is being conducted are registered to a correspondence information storage to which correspondence information establishing a correspondence between an information processing apparatus in an available state and a communication terminal is registered, when an availability notification is received from an external device which transmits an availability notification to at least one information processing apparatus selected from an information processing apparatus associated with the call-issuing-side communication terminal and an information processing apparatus associated with the call-termination-side communication terminal.

14. The information processing apparatus according to claim 13, comprising an application program controlling unit which activates, when the symbol is operated, an application program to conduct data transfer with an information processing apparatus associated with a communication terminal of a call peer.

15. A call controller, comprising:
a detecting unit which detects a call-issuing-side communication terminal and a call-termination-side communication terminal; and
a notifying unit which transmits; when a retrieval unit, which retrieves correspondence information related to the call-issuing-side and call-termination-side communication terminals detected by the detecting unit from a correspondence information storage, retrieves the correspondence information related to the call-issuing-side and call-termination-side communication terminals; an availability notification indicating availability of an information processing apparatus of a call peer to at least one information processing apparatus selected from an information processing apparatus associated with the call-issuing-side communication terminal and an information processing apparatus associated with the call-termination-side communication terminal.

16. The call controller according to claim 15, wherein:
the detecting unit detects a participation communication terminal having participated in a call being conducted between in-call communication terminals which are conducting a call; and
the notifying unit transmits an availability notification, when the retrieval unit detects correspondence information related to the participation communication terminal and correspondence information related at least to one of the in-call communication terminals, to an information processing apparatus associated with the participation communication terminal.

17. A communication support method, includes:
detecting a call-issuing-side communication terminal and a call-termination-side communication terminal;
retrieving, from a correspondence information storage to which correspondence information establishing a correspondence between an information processing apparatus in an available state and a communication terminal is registered, correspondence information related to the call-issuing-side and call-termination-side communication terminals detected by the detecting unit; and
transmitting, when the retrieval unit retrieves the correspondence information related to the call-issuing-side and call-termination-side communication terminals, an availability notification indicating availability of an information processing apparatus of a call peer to at least one information processing apparatus selected from an information processing apparatus associated with the call-issuing-side communication terminal and an information processing apparatus associated with the call-termination-side communication terminal.

18. The communication support method according to claim 17, wherein:
the detecting unit detects a participation communication terminal having participated in a call being conducted between in-call communication terminals which are conducting a call;
the retrieval unit retrieves, from the correspondence information storage, correspondence information related to the participation communication terminal and the in-call communication terminals; and
the notifying unit transmits an availability notification, when the retrieval unit detects correspondence information related to the participation communication terminal and correspondence information related at least to one of the in-call communication terminals, to an information processing apparatus associated with the participation communication terminal.

19. A storage medium for storing a program for causing a computer comprising a correspondence information storage to which correspondence information establishing a correspondence between an information processing apparatus in an available state and a communication terminal is registered, to function as a retrieval unit which inputs, from an external device, information of a call-issuing-side communication terminal and a call-termination-side communication terminal between which a call is being conducted; retrieving, from the correspondence information storage, correspondence information related to the call-issuing-side and call-termination-side communication terminals; and returning the correspondence information.

20. The storage medium for storing the program according to claim 19, wherein the retrieval unit inputs, from the external device, information of all communication terminals participating in a call; retrieves, from the correspondence information storage, correspondence information related to all of the communication terminals participating in the call; and returns the correspondence information.

21. A storage medium for storing a program for causing a computer to function as a display controlling unit which displays a symbol indicating availability of an information processing apparatus of a call peer in a situation wherein under condition that both of correspondence information pieces related to a call-issuing-side communication terminal and a call-termination-side communication terminal between which a call is being conducted are registered to a correspondence information storage to which correspondence information establishing a correspondence between an information processing apparatus in an available state and a communication terminal is registered, when an availability notification is received from an external device which transmits an availability notification to at least one information processing apparatus selected from an information processing apparatus associated with the call-issuing-side communication terminal and an information processing apparatus associated with the call-termination-side communication terminal.

22. The storage medium for storing the program according to claim 21, causing the computer to function as application program control unit for activating, when the symbol is operated, an application program to conduct data transfer with an information processing apparatus associated with a communication terminal of a call peer.

23. A storage medium for storing a program for causing a computer to function as:
a detecting unit which detects a call-issuing-side communication terminal and a call-termination-side communication terminal; and
a notifying unit which transmits; when a retrieval unit, which retrieves correspondence information related to the call-issuing-side and call-termination-side communication terminals detected by the detecting unit from a correspondence information storage, retrieves the correspondence information related to the call-issuing-side and call-termination-side communication terminals; an availability notification indicating availability of an information processing apparatus of a call peer to at least one information processing apparatus selected from an information processing apparatus associated with the call-issuing-side communication terminal and an information processing apparatus associated with the call-termination-side communication terminal.

24. The storage medium for storing the program according to claim 23, wherein:
the detecting unit detects a participation communication terminal having participated in a call being conducted between in-call communication terminals which are conducting a call; and
the notifying unit transmits an availability notification, when the retrieval unit detects correspondence information related to the participation communication terminal and correspondence information related at least to one of the in-call communication terminals, to an information processing apparatus associated with the participation communication terminal.

25. A communication support system, comprising:
a correspondence information storage to which correspondence information establishing a correspondence between an information processing apparatus in an available state and a communication terminal is registered;
detecting means for detecting a call-issuing-side communication terminal and a call-termination-side communication terminal;
retrieval means for retrieving, from the correspondence information storage, correspondence information related to the call-issuing-side and call-termination-side communication terminals detected by the detecting means; and
notifying means for transmitting, when the retrieval means retrieves the correspondence information related to the call-issuing-side and call-termination-side communication terminals, an availability notification indicating availability of an information processing apparatus of a call peer to at least one information processing apparatus selected from an information processing apparatus associated with the call-issuing-side communication terminal and an information processing apparatus associated with the call-termination-side communication terminal.

26. A correspondence information managing apparatus, comprising:
a correspondence information storage to which correspondence information establishing a correspondence between an information processing apparatus in an available state and a communication terminal is registered; and
retrieval means for inputting, from an external device, information of a call-issuing-side communication terminal and a call-termination-side communication terminal between which a call is being conducted; retrieving, from the correspondence information storage, correspondence information related to the call-issuing-side and call-termination-side communication terminals; and returning the correspondence information.

27. An information processing apparatus, comprising display control means for displaying a symbol indicating availability of an information processing apparatus of a call peer in a situation wherein under condition that both of correspondence information pieces related to a call-issuing-side communication terminal and a call-termination-side communication terminal between which a call is being conducted are registered to a correspondence information storage to which correspondence information establishing a correspondence between an information processing apparatus in an available state and a communication terminal is registered, when an availability notification is received from an external device which transmits an availability notification to at least one information processing apparatus selected from an information processing apparatus associated with the call-issuing-side communication terminal and an information processing apparatus associated with the call-termination-side communication terminal.

28. A call controller, comprising:
detecting means for detecting a call-issuing-side communication terminal and a call-termination-side communication terminal; and
notifying means for transmitting; when retrieval means, which retrieves correspondence information related to the call-issuing-side and call-termination-side communication terminals detected by the detecting means from a correspondence information storage, retrieves the correspondence information related to the call-issuing-side and call-termination-side communication terminals; an availability notification indicating availability of an information processing apparatus of a call peer to at least one information processing apparatus selected from an information processing apparatus associated with the call-issuing-side communication terminal and an information processing apparatus associated with the call-termination-side communication terminal.
